(19) United States
(12) Patent Application Publication
(10) Pub. No.: US 2026/0009275 A1
(43) Pub. Date: Jan. 8, 2026

(54) SPINDLE DRIVE DEVICE

(71) Applicant: Minebea Mitsumi Inc., Nagano-ken (JP)

(72) Inventors: Nicolas Lejeune, Landshut (DE); Frank Kummer, Augsburg (DE)

(73) Assignee: Minebea Mitsumi Inc., Nagano-ken (JP)

(21) Appl. No.: 18/763,853

(22) Filed: Jul. 3, 2024

(30) Foreign Application Priority Data
Jul. 7, 2023 (DE) 10 2023 117 944.6

(51) Int. Cl. E05F 15/622

(52) U.S. Cl. CPC E05F 15/622; E05Y 2201/10; E05Y 2201/474; E05Y 2900/53

(57) ABSTRACT

Spindle drive assembly for the motor-driven opening and closing of a motor vehicle flap or similar that comprises a spindle housing, in which a motor gear unit and a spindle unit are located, wherein the spindle unit is comprised of a fixed part of the spindle drive with a rotating spindle driven by the motor gear unit and a movable part of the spindle drive that moves in an axial direction relative to the fixed part of the spindle drive with a threaded spindle nut that grips the spindle, wherein the movable part of the spindle drive is movable in an axial direction between a retracted position and extended position due to the movable spindle nut located on the spindle, and wherein a first compression spring is foreseen, which places the fixed part of the spindle drive and the movable part of the spindle drive under tension with respect to one another, in order to assist the movable part of the spindle drive when moving from the retracted position to the extended position, wherein a second compression spring is located between the movable part of the spindle drive and the fixed part of the spindle drive, which assists the first compression spring during an opening action starting from the retracted position of the movable part of the spindle drive.

The invention concerns a spindle drive assembly according to the general concept of Patent claim 1.

In order to be able to close doors, flaps or hoods of a motor vehicle in an automatic and controlled manner, electrical drive systems in combination with passive components, such as pneumatic springs, are preferably used.

The electrical drive systems are often comprised of spindle drive assemblies, which normally contain an electrical drive system that has an effect on the moving motor vehicle flap, in order to open and/or close it.

In order to permit changing the length of the spindle drive assembly, a spindle, which is gripped by a spindle nut, is turned, and the spindle is driven by a motor gear unit. The spindle nut itself is rotationally and translationally attached to a moving part of the spindle drive. The moving part of the spindle drive can be moved linearly and directed into a static part of the spindle drive. When the spindle turns, the spindle nut is moved axially, along with the movable part of the spindle drive that is attached to the spindle nut, between a retracted position and an extended position relative to the static part of the spindle drive due to the gripping of the threads on the spindle nut.

The spindle drive assembly is attached to the motor vehicle with a fixed end and to a movable motor vehicle flap with a movable end, so that a linear movement of the spindle drive assembly is translated into an opening and closing movement of the associated motor vehicle flap or motor vehicle doors.

A spindle drive of the type described above is known from the prior art as disclosed in DE 10 2017 128 391 A1.

The known spindle drive assemblies have the problem that, in the closed position of the motor vehicle flap, there is only a small angle between the motor vehicle flap and the spindle drive assembly due to the installation method, and there is thus only a small lever available. This means that with initial small opening angles of the motor vehicle flap, a high level of motor power is needed to initiate the opening action. During the opening action, the opening angle becomes larger and, therefore, the lever becomes larger, and now a fraction of the initial motor power is necessary for continuing the opening action. Consequently, a correspondingly stronger drive motor is necessary, which requires more space for installation and causes costs to increase.

The object of the invention is to improve the function of a spindle drive assembly, particularly in the case of small opening angles of the flap being controlled.

According to the invention, this problem is solved with a spindle drive assembly with the features described in Patent claim 1.

Preferred embodiments of the invention and additional advantageous features are the subject of the subclaims.

Spindle drive assembly for the motor-driven opening and closing of a motor vehicle flap or similar that comprises a spindle housing, in which a motor gear unit and a spindle unit are located, wherein the spindle unit is comprised of a fixed part of the spindle drive with a rotating spindle driven by the motor gear unit (18) and a movable part of the spindle drive that moves in an axial direction relative to the fixed part of the spindle drive with a threaded spindle nut that grips the spindle, wherein the movable part of the spindle drive is movable in an axial direction between a retracted position and extended position due to the movable spindle nut located on the spindle, and wherein a first compression spring is foreseen, which places the fixed part of the spindle drive and the movable part of the spindle drive under tension with respect to one another, in order to assist the movable part of the spindle drive when moving from the retracted position to the extended position.

According to the invention, a second compression spring is located between the movable part of the spindle drive and the fixed part of the spindle drive, which assists the first compression spring during the opening action starting from the retracted position of the movable part of the spindle drive.

The first compression spring and the second compression spring are both under tension in the completely retracted position of the movable part of the spindle drive. During the opening action of the movable part of the spindle drive, the opening movement is assisted by the spring force of the two compression springs. While the first compression spring assists the entire opening movement, the second compression spring preferably only assists at the start of the opening movement for a certain distance.

When the motor vehicle flap is closed and the spindle drive assembly is in the retracted position, the angle, and thus the lever, between the spindle drive assembly and the flap is relatively small, so that the spindle drive assembly is only able to transfer a small amount of force to the flap. In this position, the spring force of the first compression spring is assisted by the second spring and opening of the motor vehicle flap is made easier.

Starting from the retracted position, the second compression spring assists the opening movement of the movable part of the spindle drive at least along an initial distance. According to a preferred embodiment of the invention, the second compression spring is located axially between the spindle nut and a spindle bearing mounted on a fixed component of the spindle drive. The fixed part of the spindle drive comprises a guide tube, in which a pushing rod is located that is movable in the axial direction. The pushing rod and the spindle nut attached to the pushing rod are part of the movable part of the spindle drive. The spindle grips the spindle nut and extends inside of the interior of the pushing rod. During the opening movement, the second compression spring relaxes and stops its action on the spindle nut in the relaxed state, so that only the force of the first compression spring is still acting on the movable part of the spindle drive.

According to a preferred embodiment of the invention, the second compression spring is located in an enclosed, hollow space that is resistant to dirt and watertight. This hollow space is demarcated by the guide tube, the spindle nut guided into the guide tube and a seal on the end of the guide tube that is nearest to the spindle.

In order to adjust the tension force for the initial opening action individually, the second compression spring may have a spring constant that differs from that of the first compression spring.

In particular, the second compression spring may have a higher spring constant than that of the first compression spring, so that there is a large tension force in the retracted position of the spindle drive.

A preferred embodiment of the invention is described in further detail below by means of drawings. Additional features and benefits of the invention are evident from this description.

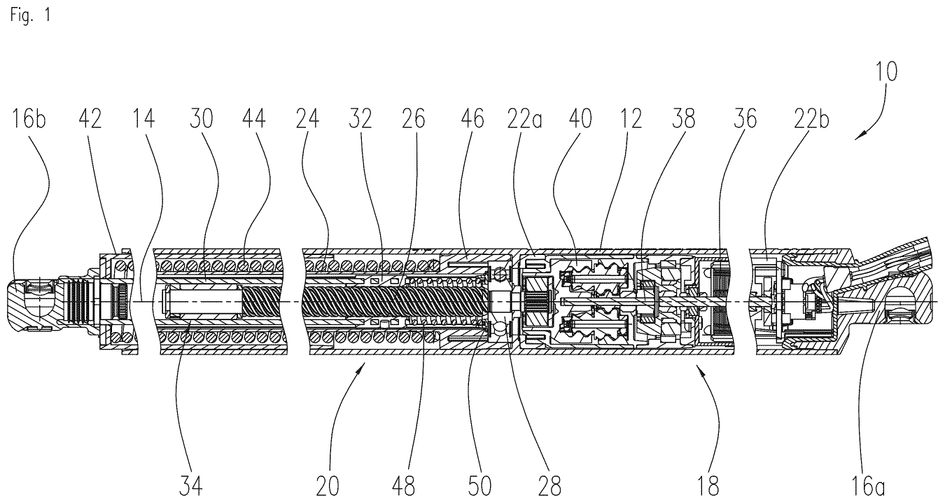

FIG. 1 shows a cross-section of a spindle drive assembly in the retracted position.

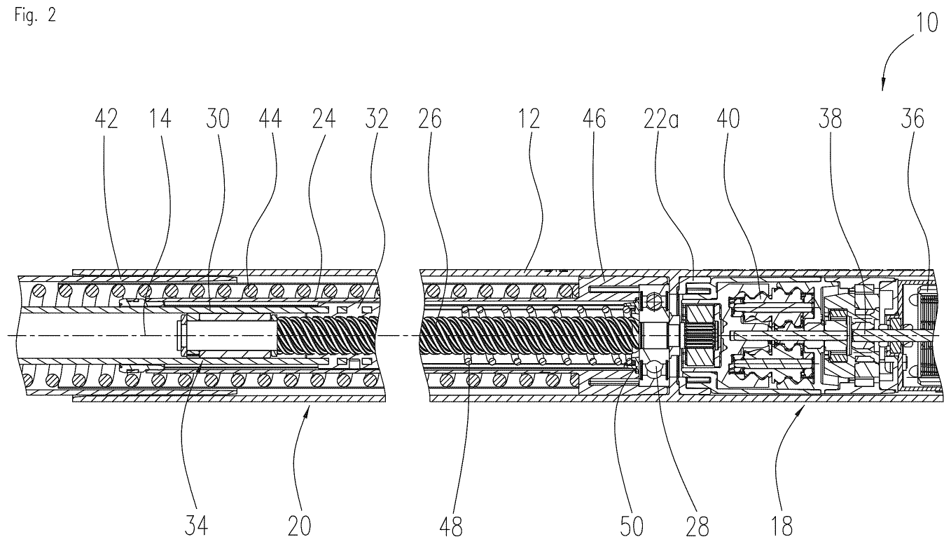

FIG. 2 shows a cross-section of a spindle drive assembly in the extended position.

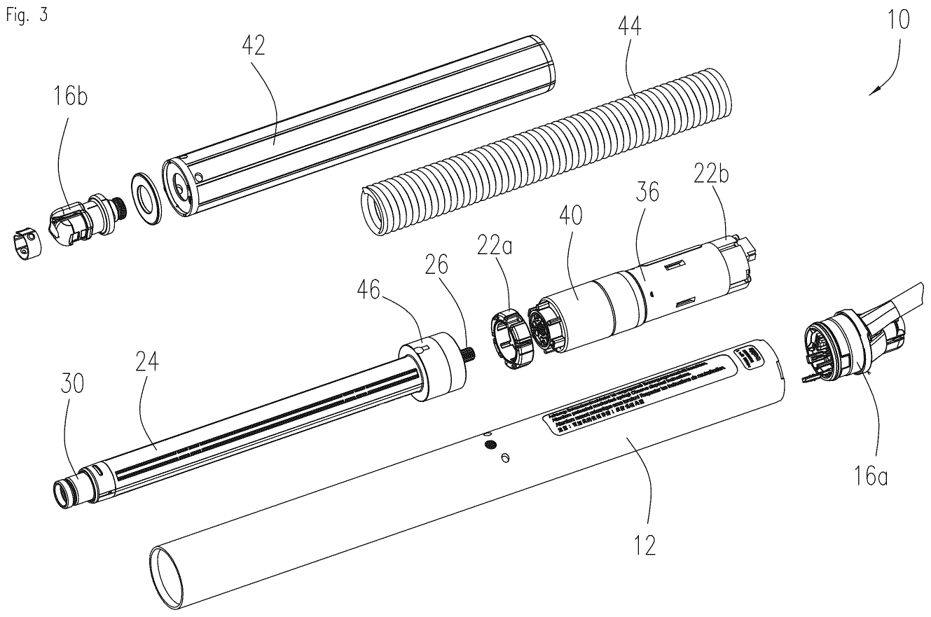

FIG. 3 shows an exploded diagram of the spindle drive assembly.

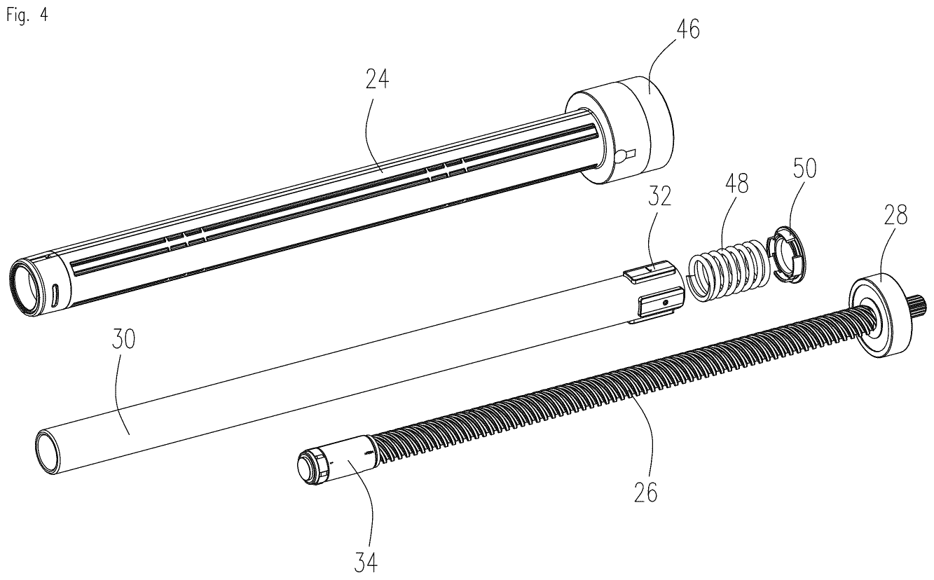

FIG. 4 shows an exploded diagram of components of the guide tube and the pushing rod.

FIG. 1 shows a spindle drive assembly 10, preferably for the motor-driven opening and closing of a motor vehicle flap (not shown) or similar.

The spindle drive assembly 10 comprises a spindle housing 12, which extends along a spindle axis 14 and possesses a first end piece 16a, which may, for example, be attached to the motor vehicle chassis. A second end piece 16b is connected to the motor vehicle flap to be controlled.

Within the spindle housing 12, there is a motor gear unit 18 and a spindle unit 20.

In the embodiment shown, the motor gear unit 18 is positioned in the spindle housing 12 in a manner that it cannot rotated, by means of two bearing components 22a, 22b.

The spindle unit 20 comprises a guide tube 24, in which a rotatable spindle 26 is located. The spindle 26 is positioned, preferably by using a roller bearing 28, on the end of the guide tube that is facing toward the motor gear unit 18.

In the embodiment shown, the guide tube 24 is attached to the spindle housing 12 by means of a bracket 46, for example by gluing or welding it to the spindle housing.

A pushing rod 30 is located between the guide tube 24 and the spindle 26, which is connected to the spindle 26 by means of a rotationally and axially fixed spindle nut 32 located at the end of the pushing rod. The spindle nut 32 may preferably be made of plastic, while the pushing rod 30 is preferably made of metal.

The spindle 26 is rotatable and axially guided into the pushing rod 30 at its free end by means of a bearing arrangement 34. The bearing arrangement 34 further serves as an end stop for the spindle nut 32, with which an axial movement of the spindle nut 32 on the spindle 26 is limited, so that the spindle nut 32 is not able to move beyond the free end of the spindle 26.

The motor gear unit 18 comprises a drive motor 36 with a drive shaft 38, which is connected to the spindle 26 by a gear 40, which is not described in detail, and which gear 40 causes the spindle 26 to rotate.

The other end of the pushing rod 30 is connected to a housing tube 42 via the end piece 16b, which tube is guided into the spindle housing 12.

If the spindle 26 is rotated by the motor gear unit 18, the spindle nut 32 and the connected pushing rod 30 make a translational movement along the spindle 26 due to the action of the threads of the spindle nut 32. Therefore, the pushing rod 30 and the connected housing tube 42 move in a telescoping manner relative to the spindle housing 12 from a retracted position to an extended position. Correspondingly, the motor vehicle flap to be controlled moves from a closed position to an open position, for example.

In the space between the housing tube 42 and the guide tube 24, there is a first compression spring 44 for assisting in providing force to the spindle drive 20 during the extension movement of the pushing rod 30 and the housing tube 42.

The compression spring 44 encloses the guide tube 24 and is supported on one end by a bracket 46 for the guide tube 24 and on the other end by the connection between the housing tube 42 and the pushing rod 30. The length of the first compression spring 44 is preferably measured in such a way that it provides force during the entire extension movement of the spindle drive.

In accordance with the invention, a second compression spring is foreseen, which is located in a space between the spindle 26 and the guide tube 24. In the retracted position of the spindle drive, a back end of the second compression spring 48 is supported on its front side by a bracket 50, which, in turn, is fitted into the spindle bearing 28, while the front end of the second compression spring 48 is supported on its front side by the spindle nut 32.

The second compression spring 48 is located in a hermetically sealed area of the spindle drive, in which no water or dirt can enter, so that no corrosion protection is necessary for the second compression spring 48.

The second compression spring 48 is used to increase the spring force acting on the movable part of the spindle drive during the opening action. As a result, the energy consumption and noise produced by the motor gear unit 18 is reduced. The length of the second compression spring 48 is preferably considerably shorter than the length of the first compression spring 44, so that the assisting force is only active over a limited initial distance during the opening action.

FIG. 2 shows the spindle drive assembly 10 in its extended position. It is evident that the pushing rod 30 and housing tube 42 are located to the left in their extended position relative to the fixed guide tube 24 and the spindle housing 12. The first compression spring 44 is also in its extended state.

The second, shorter compression spring 48 is in its fully extended relaxed state and is no longer fitted into the spindle nut 32, which is already located near the free end of the spindle 26 in the vicinity of its final position.

FIG. 3 shows an exploded view of the fundamental components of the spindle drive assembly 10 described above, especially the spindle housing 12 with the end pieces 16a, 16b, the drive motor 36 located in the spindle housing 12 with gear 40, the guide tube 24 with bracket 46 and the displaceable pushing rod 30 located therein, the first compression spring 44 and the housing tube 42 surrounding the compression spring 44.

FIG. 4 shows an exploded view of the fundamental kinematic components, particularly the guide tube 24 with bracket 46 for attaching to the inner circumference of the spindle housing 12, the pushing rod 30 located in the guide tube 24 with integrated spindle nut 32, the second compression spring 48, which is fitted into the front side of the spindle nut 32, the bracket 46 for the second compression spring 48 and the spindle 26 that is gripped by the spindle nut 32, which extends into the interior of the pushing rod 30 and can be rotated within the spindle housing 12 by means of a roller bearing 28.

### LIST OF REFERENCE NUMBERS

10 Spindle drive assembly
12 Spindle housing
14 Spindle axis
16a End piece
16b End piece
18 Motor gear unit
20 Spindle unit
22a Bearing component
22b Bearing component
24 Guide tube
26 Spindle
28 Roller bearing
30 Pushing rod
32 Spindle nut
34 Bearing arrangement
36 Drive motor
38 Motor shaft
40 Gear
42 Housing tube
44 First compression spring
46 Bracket
48 Second compression spring
50 Bracket

1. Spindle drive assembly (10) for the motor-driven opening and closing of a motor vehicle flap or similar, with a spindle housing (12), in which a motor gear unit (18) and a spindle unit (20) are located, wherein the spindle unit (20) is comprised of a fixed part of the spindle drive with a rotating spindle (26) driven by the motor gear unit (18) and a movable part of the spindle drive that moves in an axial direction relative to the fixed part of the spindle drive with a threaded spindle nut (32) that grips the spindle (26), wherein the movable part of the spindle drive is movable in an axial direction between a retracted position and extended position due to the movable spindle nut (32) located on the spindle (26), and wherein a first compression spring (44) is foreseen, which places the fixed part of the spindle drive and the movable part of the spindle drive under tension with respect to one another, in order to assist the movable part of the spindle drive when moving from the retracted position to the extended position,
characterized in that
a second compression spring (48) is located between the movable part of the spindle drive and the fixed part of the spindle drive, which assists the first compression spring (44) during an opening action starting from the retracted position of the movable part of the spindle drive.

2. A spindle drive assembly according to claim 1, characterized in that the second compression spring (48) assists the movable part of the spindle drive at least along an initial distance starting from its retracted position.

3. A spindle drive assembly according to claim 1, characterized in that the second compression spring (48) is located axially between the spindle nut (32) and a spindle bearing (28) attached to the fixed spindle component and within a pushing rod 30.

4. A spindle drive assembly according to claim 1, characterized in that the second compression spring (48) is located in a hollow space that is enclosed, resistant to dirt and watertight.

5. A spindle drive assembly according to claim 1, characterized in that the second compression spring (48) has a spring constant that differs from that of the first compression spring (44).

6. A spindle drive assembly according to claim 1, characterized in that the second compression spring (48) has a higher spring constant than that of the first compression spring (44).
